(19) United States
(12) Patent Application Publication
(10) Pub. No.: US 2009/0100430 A1
(43) Pub. Date: Apr. 16, 2009

(54) METHOD AND SYSTEM FOR A TASK AUTOMATION TOOL

(76) Inventors: Marco Valentin, Malsch (DE); Christian Gaertner, Oestringen (DE); Stefan Tex, Pfinztal (DE)

Correspondence Address: SAP AG, 3410 HILLVIEW AVENUE, PALO ALTO, CA, 94304, US

(21) Appl. No.: 11/872,050

(22) Filed: Oct. 15, 2007

(51) Int. Cl. G06F 9/46

(52) U.S. Cl. 718/102

(57) ABSTRACT

Disclosed is a method and system for receiving a task list containing a task, determining if the task must be executed based on a context of a business scenario and executing the task. After executing the task, a result of execution of the task is analyzed based on the context of the business scenario and an operation to be performed is determined based on the result of the execution.

### FIELD OF THE INVENTION

The invention generally relates to the field of a task scheduling software and more specifically to a task automation tool for processing the tasks intelligently.

### BACKGROUND OF THE INVENTION

Scheduling software typically executes a set of tasks specified in a task list. A sequence of execution of the tasks in the task list is typically defined by a user. The scheduling software is capable of handling errors that arise during the execution of the tasks but error handling capabilities are typically limited to just logging the error in a trace file and terminating the task. The scheduling software then proceeds with a next task from the task list or terminate the execution of the task list. The scheduling software does not automatically fix the error.

The scheduling software typically handles errors that arise due to technical reasons such as a database not responding, no database table, file not found, class not found, memory not enough, and no network connection. The scheduling software is typically not capable of handling application errors such as data in a payroll table is not in compliance with payroll standards, and data in an inventory table not matching with purchase data. The application errors are the errors that are determined based on application logic of a business scenario. The scheduling software typically does not understand application errors as it is not capable of understanding the business scenario of the task being executed. Therefore, the scheduling software cannot attempt to fix application errors. Also the scheduling software typically does not have the capability to change the sequence of execution of the tasks once defined in the task list.

### SUMMARY OF THE INVENTION

What is described is a method and system for receiving a task list containing a task, determining if the task must be executed based on a context of a business scenario and executing the task. After executing the task, a result of execution of the task is analyzed based on the context of the business scenario and an operation to be performed is determined based on the result of the execution.

### BRIEF DESCRIPTION OF THE DRAWINGS

FIG. 1 is a flow diagram for processing a task from a task list according to an embodiment of the invention.

FIG. 2 is a flow diagram in detail for processing a task from a task list according to an embodiment of the invention.

FIG. 3 is a block diagram of various components of a task automation tool for processing tasks from a task list according to an embodiment of the invention.

FIG. 4 is a block diagram of various components of a task automation tool to communicate with an application according to an embodiment of the invention.

FIG. 5 is an exemplary business scenario executed using a task automation tool according to an embodiment of the invention.

### DETAILED DESCRIPTION

What is described is a method and system for receiving a task list containing a task, determining if the task must be executed based on a context of a business scenario and executing the task. After executing the task, a result of execution of the task is analyzed based on the context of the business scenario and an operation to be performed is determined based on the result of the execution.

Task automation tool eliminates user intervention required in processing huge tasks such as upgrading an enterprise software application. Processing a number of tasks using task automation tool makes it easier for the user since the task automation tool processes the tasks automatically in a defined sequence, handles any error that occurs during the execution of the task by attempting to fix the error automatically based on the context of the business scenario of the task and enables the user to monitor a status of the tasks that are executed. Task automation tool reduces the amount of time consumed in executing the tasks by eliminating user intervention and reduces the number of errors that may occur otherwise because of human intervention. Also, task automation tool processes the tasks in the required order which eliminates a need for the user to know the order in which the task must be executed, if the task is executed manually.

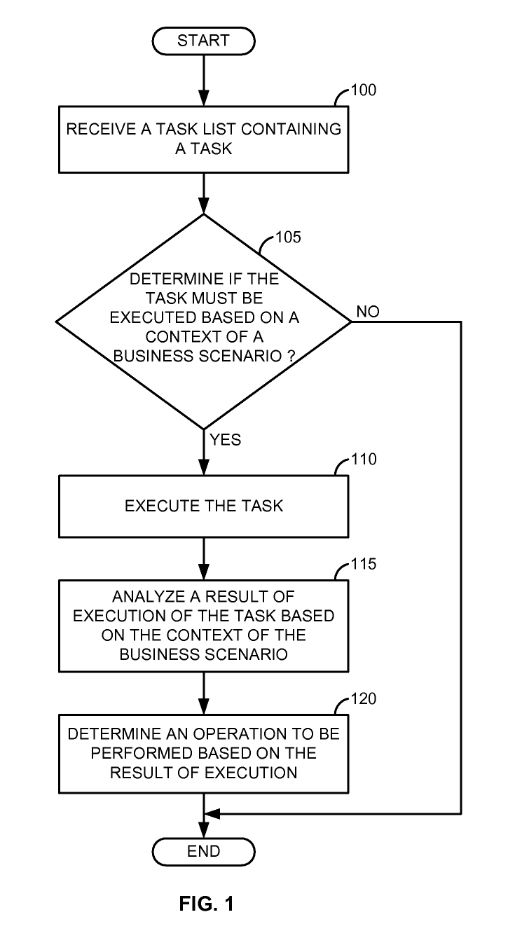

FIG. 1 is a flow diagram for processing a task from a task list according to an embodiment of the invention. At step 100, a task list containing a task is received by a task automation tool. In an embodiment, the task list contains a number of tasks of a business scenario. The task includes a step of a business process, the business process, a business scenario, a database update, and sending an electronic mail. A business scenario could be a scenario such as a sales scenario where in a sales representative takes a sales order from a customer, verifies if a product requested is in stock and calculates a price of the product based on some rules. A business process could be a process such as creating a sales order for the customer. At step 105, a determination is made whether the task from the task list must be executed based on a context of a business scenario. If a determination is made to execute the task, then at step 110, the task is executed by the task automation tool. At step 115, a result of execution of the task is analyzed based on the context of the business scenario. The result of execution of the task includes values such as a success and a failure. At step 120, the task automation tool determines an operation to be performed based on the result of execution of the task.

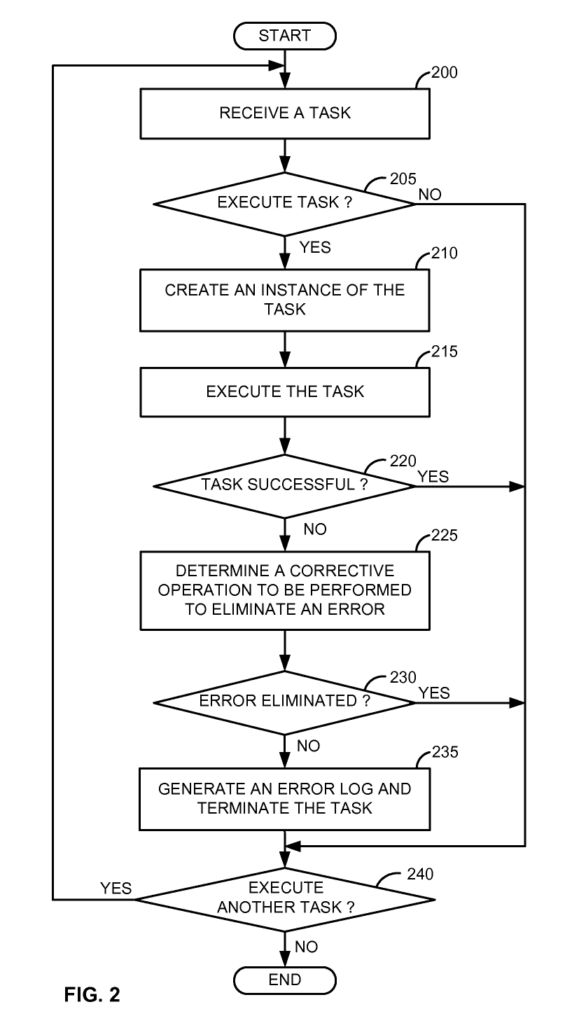

FIG. 2 is a flow diagram in detail for processing a task from a task list according to an embodiment of the invention. At step 200, the task automation tool receives a task from a task list. In an embodiment, the task list is received in an extensible markup language (XML) format. At step 205, a determination is made whether to execute the task. The task automation tool determines whether to execute the task based on a context of a business scenario in which the task is executed. For example, consider a task list that contains a task such as checking the consistency of a database table containing details regarding promotional offers for a product. The task automation tool communicates with a sales application to which the task belongs and finds out the context of the business scenario, that is, if there are any promotional offers available for the product. If the promotional offers are available, only then the task automation tool would execute the task for checking the consistency of the database table containing the details of the promotional offers. The task automation tool checks whether the task has to be executed based on the context of the business scenario as described above. Also, when the task list is received, the task automation tool determines a sequence of execution of tasks in the task list based on a sequence number defined in the task list.

At step 205, if the task automation tool determines to execute the task, an instance of the task is created at step 210. At step 205, if the task automation tool determines not to execute the task, the control is transferred to step 240. After creating the instance, the task is executed at step 215. The task automation tool determines whether the task has executed successfully at step 220. A result of execution of the task is analyzed based on the context of the business scenario of the task. The result of execution of the task includes values such as a success and a failure. The result of execution is determined as success only if the task has executed successfully based on the business scenario and not based on technical correctness. For example, consider the task such as checking the consistency of a database table containing details regarding promotional offers for a product. When the task is executed, the task automation tool checks the consistency of the database table with respect to necessary details of the promotional offers of the product as per the sales application and not just checking for a technical correctness such as a presence some arbitrary data in the database table. In an embodiment, the necessary details of the promotional offers could be details such as whether a discount offered for the product is within the permissible discount range, whether discount is applicable to all customers, duration of the discount, and region where the discount is offered. The task automation tool checks whether there is a right promotional offer for the right product. Only if the task has executed successfully based on the context of the business scenario, the result of execution is determined as success. After the task has executed successfully, the control is transferred to step 240.

If there is an error in the execution of the task, the result of execution is determined as failure. If the task has not executed successfully, at step 225, the task automation tool determines a corrective operation to be performed to eliminate the error in the execution of the task. The task automation tool determines the corrective operation to be performed based on the context of the business scenario of the task. The corrective operation may include executing a task from the task list, and executing a new task which is not there in the task list. For example, consider a task such as checking the consistency of a database table containing details regarding promotional offers for a product. If the task fails for a reason such as the database table being non-existent, the task automation tool instead of terminating the task with a “no database table” message, it would attempt to fix the error by trying to create a database table containing details of the promotional offers for the product. In order to create the database table, the task automation tool would typically communicate with the sales application to get the details of the database table and the promotional offers. In another embodiment, the task automation tool may execute another task from the task list that creates a database table for the promotional offers of the product in which case the task automation tool would change the sequence of execution of the task based on the corrective operation performed.

At step 230, it is determined if the error is eliminated by performing the corrective operation. If the error is eliminated, the control is transferred to step 240. If the error is not eliminated, then the task automation tool generates an error log and terminates the task as indicated in step 235. A user is notified regarding the error in a monitoring unit. In an embodiment, the error is notified as a pop-up window on a display unit. Based on the error, the task automation tool determines whether to proceed with executing next task from the task list or terminate execution of the task list. In an embodiment, if the error is a fatal error, the task automation tool may terminate executing the task list. If the error is not a fatal error, the task automation tool may continue executing the remaining tasks from the task list. At step 240, the task automation tool determines if there are more tasks to be executed. If there are more tasks to be executed, the control is transferred to step 200.

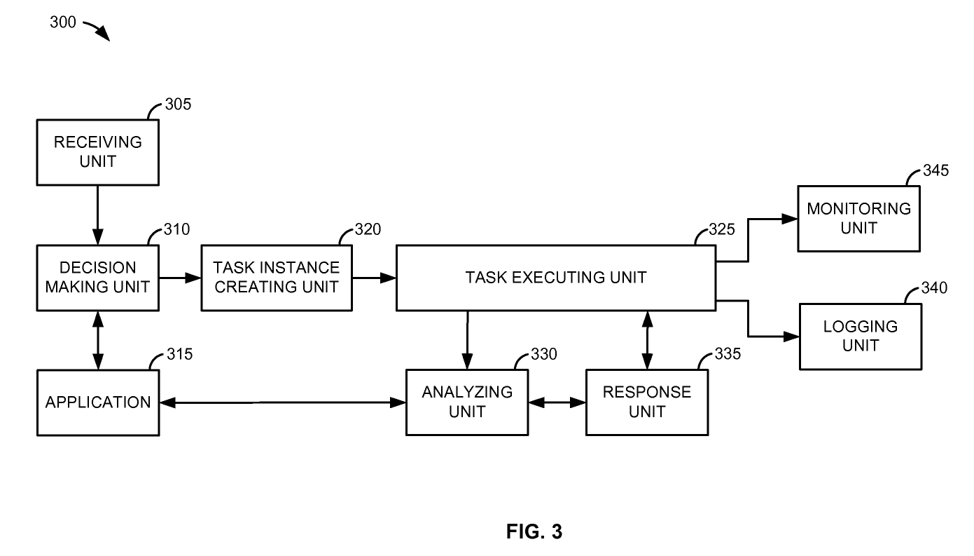

FIG. 3 is a block diagram of various components of a task automation tool for processing tasks from a task list according to an embodiment of the invention. Task automation tool 300 includes a receiving unit 305 to receive a task list containing a set of tasks to be processed. In an embodiment, the task list is received in XML format. The task list includes details such as a name of the task, an application to which the task belongs, a component to which the task belongs, a priority of the task, and an execution sequence of the task. Decision making unit 310 electronically coupled to receiving unit 305 reads a task from the task list and determines if the task has to be executed. In an embodiment, decision making unit 310 is electronically coupled to receiving unit 305 via a system bus. Decision making unit 310 makes the determination based on the context of the business scenario in which the task is executed. Decision making unit 310 determines the context of the business scenario by communicating with application 315 to determine the context of the business scenario of the task. Application 315 includes applications such as customer relationship management, finance, human resource, and supply chain management.

Task instance creating unit 320 electronically coupled to decision making unit 310 creates an instance of the task which is executed by task executing unit 325. Analyzing unit 330 electronically coupled to task executing unit 325 analyzes a result of execution of the task. In an embodiment, analyzing unit 310 is electronically coupled to task executing unit 325 via the system bus. The result of execution is determined as a success or failure based on the context of the business scenario of the task. Analyzing unit 330 communicates with application 315 to determine the context of the business scenario of the task. If the result of execution of the task is a failure, response unit 335 electronically coupled to analyzing unit 330 attempts to fix an error in the execution of the task by executing a corrective operation.

Logging unit 340 electronically coupled to task executing unit 325 generates a report including task execution information such as an error in the execution of the task, a warning, and other information related to the task such as priority of the task, resource availability, license key if the task is using licensed software, execution time allocated to the user, number of simultaneous jobs allowed for the user, estimated execution time of the task, elapsed execution time of the task, availability of peripheral devices, and occurrence of prescribed events. Monitoring unit 345 enables the user to monitor the execution of the tasks. Monitoring unit 345 provides a user interface that displays information regarding the execution of the task as described above. Monitoring unit 345 also raises an alarm in the case of a failure of the task and enables the user to perform an operation on the task.

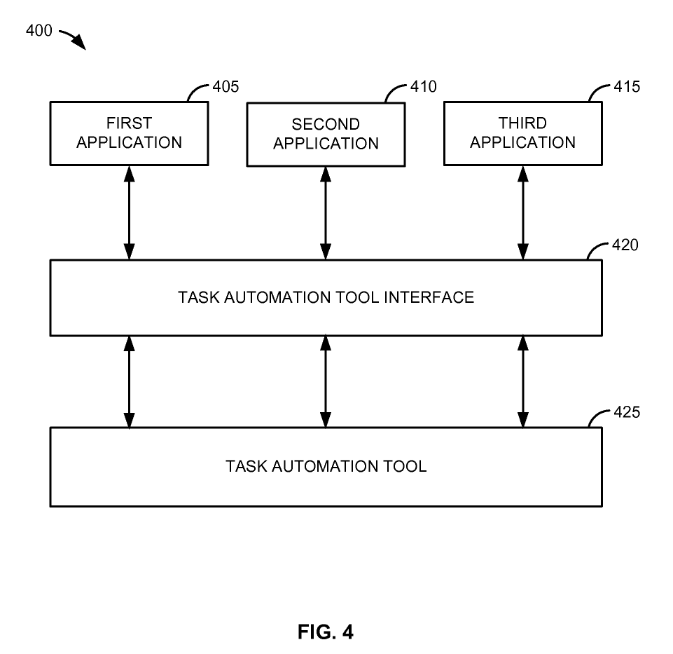

FIG. 4 is a block diagram of various components of a task automation tool to communicate with an application according to an embodiment of the invention. System 400 includes task automation tool 425 that processes tasks from first application 405, second application 410, and third application 415. Applications communicate with task automation tool 425 via task automation tool interface 420. Task automation tool interface 420 is generated by a task automation tool interface generating unit. Task automation tool interface 420 provides an application programming interface (API) for applications to communicate with task automation tool 425. First application 405, second application 410, and third application 415 include applications such as customer relationship management, finance, human resource, and supply chain management. In an embodiment, task automation tool 425 communicates with first application 405, second application 410, and third application 415 using the API to determine a context of a business scenario of the task.

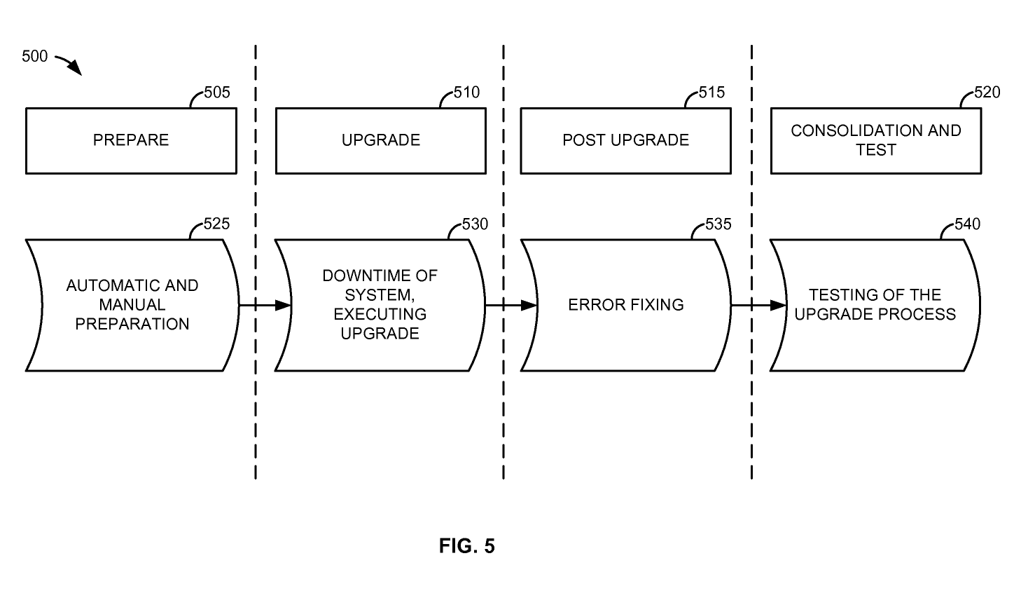

FIG. 5 is an exemplary business scenario executed using a task automation tool according to an embodiment of the invention. Business scenario 500 depicts a scenario for upgrading an enterprise application software in an enterprise system. Business scenario 500 includes various phases such as prepare 505, upgrade 510, post upgrade 515, and consolidation and test 520. Prepare 505 phase includes automatic and manual preparation 525 for the upgrade process. In an embodiment, automatic and manual preparation 525, task automation tool 300 in FIG. 3 analyzes a status of a database and memory in the enterprise system, verifies if all necessary configurations are made in the enterprise system for the upgrade, verifies if all necessary application components required for the upgrade are present, determines from a given task list the tasks that have to be executed based on a context of the business scenario and the user may check any other required settings for the upgrade of the system.

Upgrade 510 is the phase wherein the enterprise application software in the enterprise system is upgraded by task automation tool 300. Upgrade 510 phase includes a downtime of system as the upgrade task would be executing as indicated by activity 530. Task automation tool 300 determines what components of the enterprise application software have to be updated. If task automation tool 300 determines that the enterprise application already has a latest version of a component, then task automation tool 300 does not execute an upgrade process for the component.

Post upgrade 515 phase includes activities such as error fixing 535. Task automation tool 300 attempts to fix any errors caused during upgrade 510 phase. For the errors that may need user intervention, task automation tool 300 prompts the user to fix the error and the user may fix the error manually.

Consolidation and test 520 phase includes activities such as testing of the upgrade process 540. Task automation tool 300 verifies if the upgrade 530 has executed successfully by testing the enterprise application with a set of test cases. The test checks for parameters that include, but are not limited to, compatibility of various application components in the enterprise application software, consistency of various application components, verifying if features that are included as part of the upgrade are working in the enterprise application. Consolidation and test 520 also includes consolidation activities such as initializing necessary application components, and customizing application components.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or any other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method, comprising:
receiving a task list containing a task;
determining if the task must be executed based on a context of a business scenario;
executing the task;
analyzing a result of execution of the task based on the context of the business scenario; and
determining an operation to be performed based on the result of the execution.

2. The method in claim 1, further comprising communicating with an application in the business scenario to determine the context of the business scenario.

3. The method in claim 1, wherein analyzing a result of execution of the task comprises determining whether the result of execution is successful based on the context of the business scenario.

4. The method in claim 1, wherein determining an operation to be performed comprises executing a corrective operation to eliminate an error if the result of execution of the task is a failure.

5. The method in claim 4, wherein the corrective operation comprises an operation selected from a group consisting of executing a new task which is not in the list, changing a sequence of execution of a task that has failed, terminating a task that has failed and terminating an execution of the task list.

6. The method in claim 1 further comprising generating a report including information related to the execution of the task.

7. The method in claim 1, wherein the task comprises an operation selected from a group consisting of a step of a business process, a business process, a business scenario, a database update, sending email, and generating a report.

8. The method in claim 1 further comprising monitoring the task after the task starts executing.

9. A system, comprising:
a receiving unit to receive a task list containing a task;
a decision making unit electronically coupled to the receiving unit to determine if the task must be executed based on a context of a business scenario;
a task executing unit electronically coupled to the decision making unit to execute the task;
an analyzing unit electronically coupled to the task executing unit to analyze a result of execution of the task based on the context of the business scenario; and
a response unit electronically coupled to the analyzing unit to determine an operation to be performed based on the result of the execution.

10. The system in claim 9 further comprising a task instance creating unit electronically coupled to the decision making unit to create an instance of the task.

11. The system in claim 9 further comprising a task automation tool interface generating unit electronically coupled to a task automation tool to generate a task automation tool interface that acts as an interface between an application and the task automation tool.

12. An article of manufacture, comprising:
a machine readable medium having instructions which when executed by a machine cause the machine to:
receive a task list containing a task;
determine if the task must be executed based on a context of a business scenario;
execute the task;
analyze a result of execution of the task based on the context of the business scenario; and
determine an operation to be performed based on the result of the execution.

13. The article of manufacture in claim 12, wherein the machine readable medium provides instructions, which when executed by a machine cause the machine to analyze a result of execution of the task comprises determining whether the result of execution is successful based on the context of the business scenario in which the task is executed.

14. The article of manufacture in claim 12, wherein the machine readable medium provides instructions, which when executed by a machine cause the machine to determine an operation to be performed comprises executing a corrective operation to eliminate an error if the result of the execution of the task is a failure.
